(19) United States
(12) Patent Application Publication
(10) Pub. No.: US 2003/0108855 A1
(43) Pub. Date: Jun. 12, 2003

(54) Book that can read languages and sentences

(75) Inventor: Chi Kuen Chan, Kwai Chung (HK)

Correspondence Address: SEED INTELLECTUAL PROPERTY LAW GROUP PLLC, 701 FIFTH AVE, SUITE 6300, SEATTLE, WA, 98104-7092, US

(73) Assignee: Wide Concept Limited, Hong Kong (CN)

(21) Appl. No.: 10/286,665

(22) Filed: Oct. 31, 2002

Related U.S. Application Data
(63) Continuation-in-part of application No. 10/064,351, filed on Jul. 3, 2002.

(30) Foreign Application Priority Data
Dec. 12, 2001 (CN) 01278183.5

(51) Int. Cl. G09B 5/00

(52) U.S. Cl. 434/317

(57) ABSTRACT

A book device includes a book and a speech circuit. The speech circuit includes a printed circuit formed on a composite membrane affixed to the cover of the book. The composite membrane includes a first dielectric film on which a first circuit portion, including plural first circuit modules, has been printed and a second dielectric film on which a second circuit portion, including plural second circuit modules, has been printed. One of the films also includes a pattern of dielectric ink dots that insulate the first circuit modules from the second circuit modules. The pattern of ink dots is such that when a user presses an object in the book that overlies one of the first circuit modules, the conductive lines of the first circuit module contact the conductive lines a correspond second circuit module, thereby closing one or more switches of the circuit.

### CROSS-REFERENCE TO RELATED APPLICATION

This application is a continuation-in-part of U.S. patent application Ser. No. 10/064,351, filed Jul. 3, 2002, now pending, which application is incorporated herein by reference in its entirety.

### BACKGROUND OF THE INVENTION

1. Field of the Invention

The present utility model relates to a kind of book, particularly the kind of book for minors that can read languages and sentences.

2. Description of the Related Art

Education is a large-scale industry. The pre-school education and foreign language education depend on reading. Many factories consider how to arouse the interest of minors or even the students and parents to study and how to make books more interesting. At present, all the books are only printed in words that cannot read aloud themselves. If there are books that can read languages and sentences, it would be welcomed by the market

### BRIEF SUMMARY OF THE INVENTION

An embodiment of the present invention provides for minors books that can read aloud languages and sentences.

It is a kind of book which can speak languages and sentences. It is a book that includes a speech circuit for reading out the specified sentences in the book. The speech circuit includes a printed circuit board containing press triggers on which there are a number of speech switches, a circuit for storage and sound emission, a speaker, and a battery. The printed circuit board containing press triggers is inside the cover of the book. The circuit for storage and sound emission, speaker, and battery are placed in a box-like container outside the book. The internal and external part of the speech circuit are connected by a wire. The circuit for storage and sound emission stores all the sound to be emitted. The speech switches are switched on when pressing different pictures on the book. The speaker would then read aloud the contents of the pictures. The battery supplies electricity for the whole circuit.

A book constructed in this manner can read aloud the sentences in the book and the contents of the books. Matching with the pictures in the books, it is particularly suitable for pre-school education and learning of foreign language by children. Not only they benefit the learning of children and students, they also facilitate assistance from parents to the children. With the assistance of this book, foreign language and common knowledge can be learned and it would also foster social morality.

In one embodiment, the speech circuit implements the press triggers in a circuit of a composite plastic membrane located in the cover of the book. The composite plastic membrane includes a first plastic film on which metal lines of a circuit have been printed and a second plastic film on which concentric squares of metal lines have been printed. One of the plastic films also includes a pattern of dielectric ink dots that insulate the concentric squares of metal lines from the metal lines of the circuit. The pattern of ink dots is such that when a user presses an object in the book that overlies one of the concentric squares, the metal lines of the concentric square contact a portion of the metal lines of the circuit printed on the first plastic film, thereby closing one or more switches of the circuit. The closing of the switch or switches sends a signal to the external circuit to cause the internal circuit to perform one or more functions, such as emitting sounds corresponding to the object in the book that was pressed by the user.

### BRIEF DESCRIPTION OF THE DRAWINGS

FIG. 1 illustrates the appearance and structure of a book that can read languages and sentences according to an embodiment of the present invention.

FIG. 2 illustrates the speech circuit's block diagram of the book shown in FIG. 1.

FIG. 3 illustrates a page of the book shown in FIG. 1.

FIG. 4 illustrates another page of the book shown in FIG. 1.

FIG. 5A illustrates the speech circuit of the book shown in FIG. 1.

FIG. 5B is an amplification of part of the circuit for storage and sound emission (23) shown in FIG. 5A.

FIG. 6 illustrates another page of the book shown in FIG. 1.

FIGS. 7A-7b show a schematic diagram of speech circuitry printed on a first plastic film of a composite membrane positioned in a cover of the book shown in FIG. 1.

FIG. 8 is a schematic diagram of an arrangement of square patterns of metal lines printed on a second plastic film of the composite membrane positioned in the cover of the book shown in FIG. 1.

FIG. 9 is a schematic diagram of a pattern of dielectric ink dots printed on the first plastic film shown in FIG. 7.

The following is a detailed description, when combined with the attached figures, on the structural features of a book that can read languages and sentences according to an embodiment of the present invention.

### DETAILED DESCRIPTION OF IMPLEMENTATION

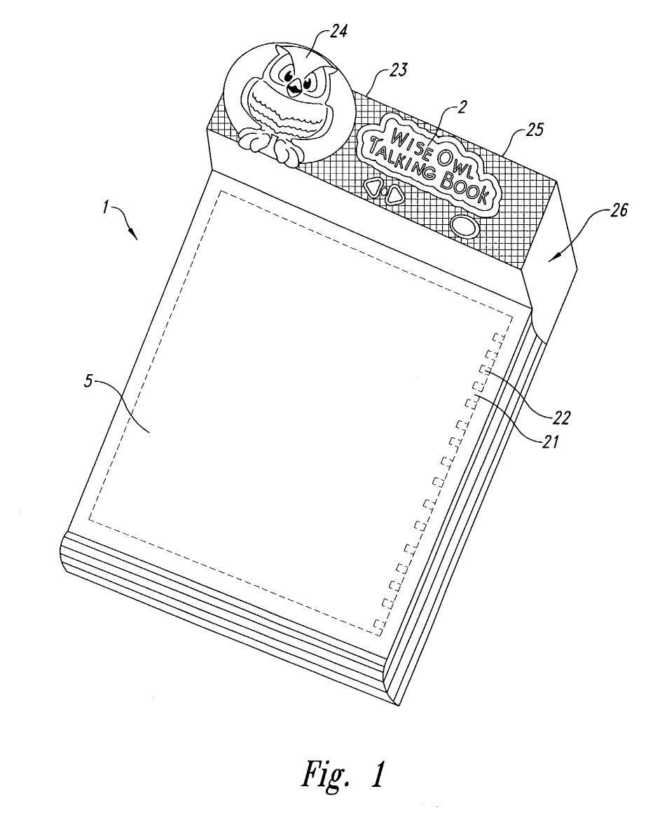

FIG. 1 illustrates the appearance and structure of a book that can read languages and sentences according to an embodiment of the present invention. The present book includes a book (1) and a speech circuit (2). A press trigger printed circuit board (PCB) (21) of the speech circuit (2) is placed inside the cover of the book. A hard cover is preferred to reduce the possibility of damage of the press trigger PCB (21) caused by bending and rubbing. In the book, a rub-proof insulating soft film is used as the substrate of the press trigger PCB, i.e., one can place the soft film press trigger PCB (21) inside the cover of the book. It can be placed in the soft cover of a book. Of course, any other press trigger PCB with similar capabilities can be used. The box-like container (26) shown in FIG. 1 shows a circuit for storage and sound emission (23), a speaker (24) and a battery (25). The box-like container can usually be connected to the book (1) in a fixed manner. The box-like container (26) can be manufactured in a number of interesting shapes, for example, in the form of a pencil box. To match the content of the book, it can be in the shape of a candy box and a dressing case for cosmetics, etc. The box can become a toy book or a learning book, etc. to increase the spectrum of customers for the book. In relation to the circuit for storage and sound emission (23), it adopts the IC block HE80320 AND HE167340 or similar circuit (not limited to such models).

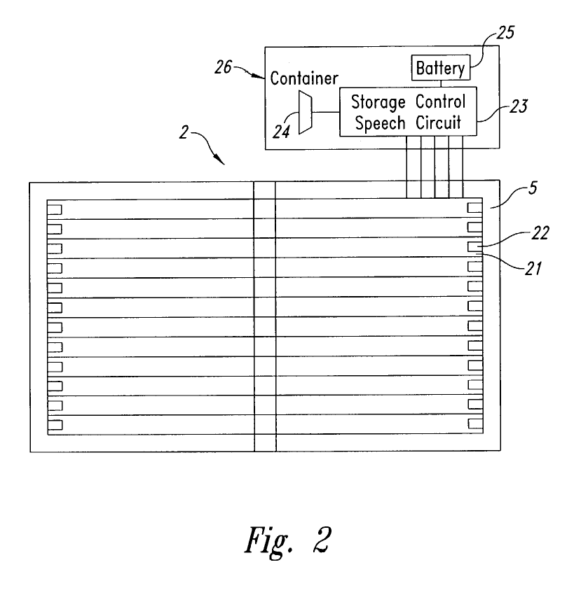

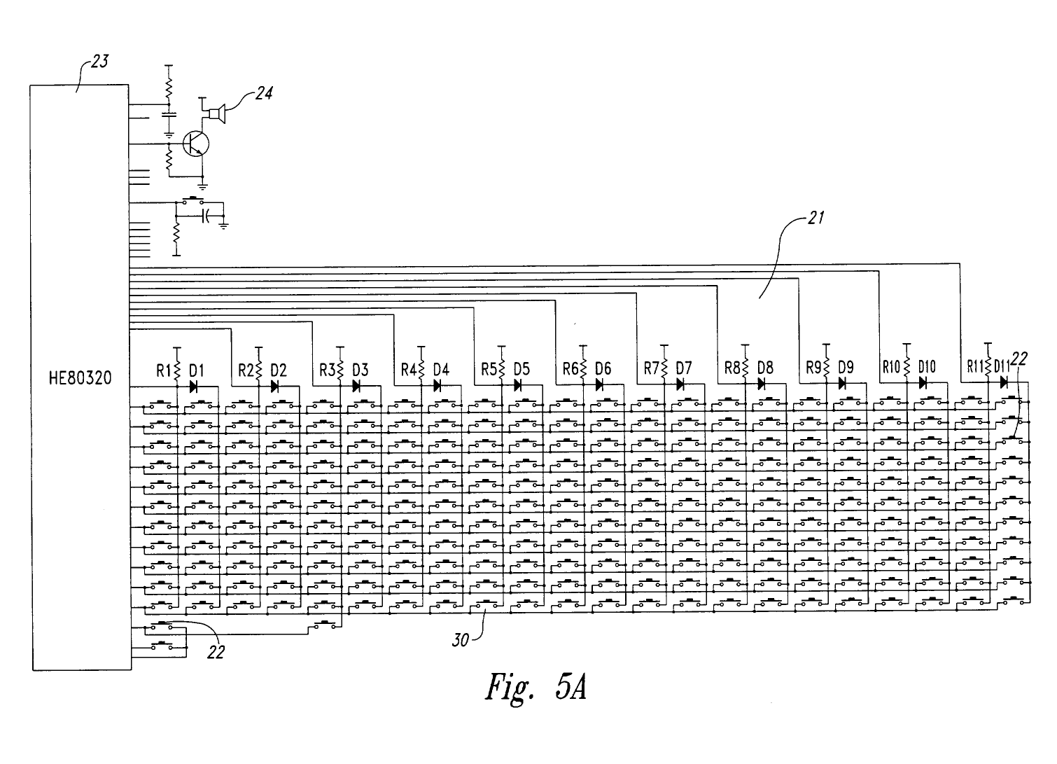

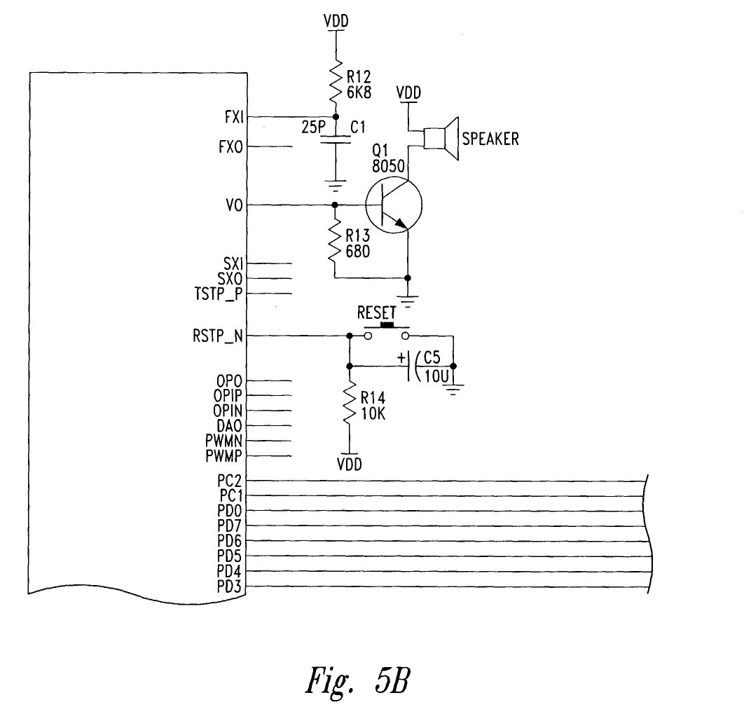

FIG. 2 illustrates the speech circuit's (2) block diagram of a book that can read languages and sentences according to the present utility model shown in FIG. 1. As shown in FIG. 2, a large piece of printed circuit board with press triggers (21) with a number of speech switches (30) on it (shown in FIG. 5A), is placed inside the cover of the book. The outer cover of the book is marked as label 5. The figure shows that the outer cover is open. The box-like container (26) contains a speaker (24), a circuit for storage and sound emission (23) and a battery (25). The thin film circuit on the press trigger PCB (21) is connected to circuit for storage and sound emission (23) so that the whole circuit can have electricity. Usually, the battery is used to supply electricity to the whole circuit so that the book becomes portable. All the sound of the languages would be entered into and recorded in advance in the circuit for storage and sound emission (23). When the speech switch for sound emission (30) is pressed and that part of circuit connected, the circuit for storage and sound emission (23) for that speech switch would be connected according to the configuration of the circuit.

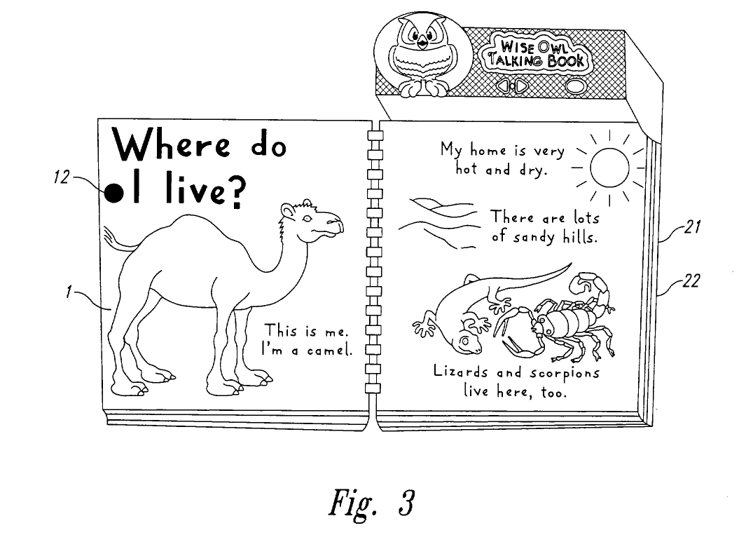

Furthermore, a number of press trigger switches (22) can be arranged near the margins of the press trigger PCB (21) (FIG. 3). On every page, there is a spot above each press trigger (22) (FIG. 3). The purpose of this structure is to enable matching of the spot on each page with the press-trigger on the circuit. When turning to a certain page, one can press a page selection contact (12) to switch on the corresponding press-trigger switch (22), and then press or touch the pictures on that page to switch on the corresponding press trigger switch (30). The speaker would emit sound reading out aloud the pre-recorded sound associated with the selected pictures. If you directly press the pictures without pressing the page selection contact, the sound coming out would not correspond to the picture on the selected page but to that of the previous page or the next page.

The function keys of repeat and stop can be inserted by setting up switches. These functions can be left out. The operation procedure can be in various ways decided by the Manufacturing factory.

FIG. 3 illustrates the location of the page selection contact of the book shown in FIG. 1. On the margin of every page, there is a circular page selection contact (12) shown in FIG. 3. Circular contact is used only as an example. Of course, any other shapes can be used. One can press this contact (12) to switch on the corresponding press trigger switch (22) located inside the cover of the book, then press the different pictures to switch on the corresponding speech switches (30). The sound corresponding to the different pictures can be sent out. For the picture shown in FIG. 3, one can press the page selection contact (12) on this page, then press the camel on the left and upper part of the page, it will read aloud “This is me, I'm a camel”. If one presses the sun on the top right hand corner, it will read aloud “My home is very hot and dry.”. The voice that comes out would differ depending on different books, different content, different languages used, different voices, different intonations and different sound effect.

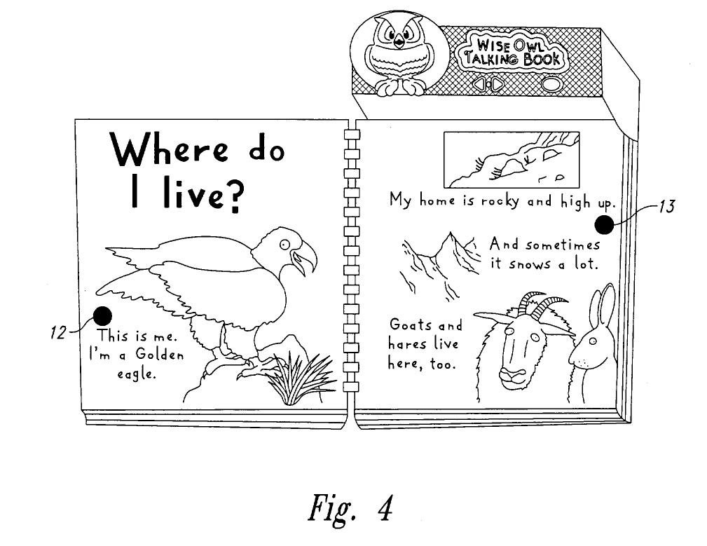

FIG. 4 shows the picture from a different page. Each time a page is turned, one must press the page selection contact (12) on the margin of the selected page first, then press the photographs on that page. Referring to the page shown in FIG. 4. First, press the page selection contact (12), then press the eagle on the left hand side and it will read aloud “This is me, I am a golden eagle”. Press the bottom at the right lower corner and it will read aloud “Goats and hares live here, too.”.

The purpose of the page selection contact (12) is to match the images on every page with the pre-recorded voices correctly. If you press an image without pressing the page selection contact (12), it will emit the sound corresponding to the picture on the previous page.

Another way to deal with the problem is to insert a stop contact (13) on every page. After finishing a page, press the stop contact (13) to terminate the voice. Then turn to another page and press the page selection contact (12) to begin reading the new page. When finish reading, press the stop contact (13). If the stop contact (13) is not pressed, when reading another page, the previous page's voice will be repeated if the reader forgets to press the page selection contact (12). However, with the stop contact, when the reader reads another page, even if he forgets to press the page selection contact (12), the previous page's voice would not be repeated. There would be no sound.

There are many ways in placing the page selection contact (12) in the book. It is critical that the page selection contact must correspond in position with the press trigger switch (22) in the press trigger PCB (21). One page selection contact (12) corresponds in position only with one press trigger switch (22). Therefore, the page selection contact (12) on one page should not be in the same position as that of another page. For example, the selection contact on the fist page is placed on the top left corner. The selection contact of the second page is placed in a position lower than the selection contact of the first page. This continues so on and so forth). As to whether one selection contact controls 1 page or 2 pages when a book is in the open position, it does not really matters. This can be determined by the number of pages of the book and the number of selection contacts. All page selection contacts (12) are arranged along the margins and all stop contacts (13) are located at the same position, such as the top right hand corner of every page.

The press trigger PCB will not be damaged on opening the book or turning a page as it is soft and all the acts like opening a book and turning a page are taken into account in designing the book. The other number and symbols in FIG. 4 have the same meanings as those in FIG. 1 and FIG. 2.

FIG. 5A and FIG. 5B illustrate the speech circuit (2) of the book illustrated from FIG. 1 to FIG. 4. The present embodiment adopts IC block HE80320, associated with resistance R12, R13 and R14, a triode A1, capacitance C1 and C5 to form the circuit controlling storage and sound emission (23). The speaker (24) is also shown in the figure and the battery (25) powers the circuit system via VDD. The matrix part is the gum-film press trigger PCB (21) on which there are many speech switches (30) corresponding to the different pictures. The number of the speech switches (30) may be 242 (22 columns*11 rows) (of course, it can be increased or decreased according to the contents of the book or the number of the speech contacts). There are 11 resistances named from R1 to R11 and 11 diodes with which the circuit is made up to realize the speaking function of the book.

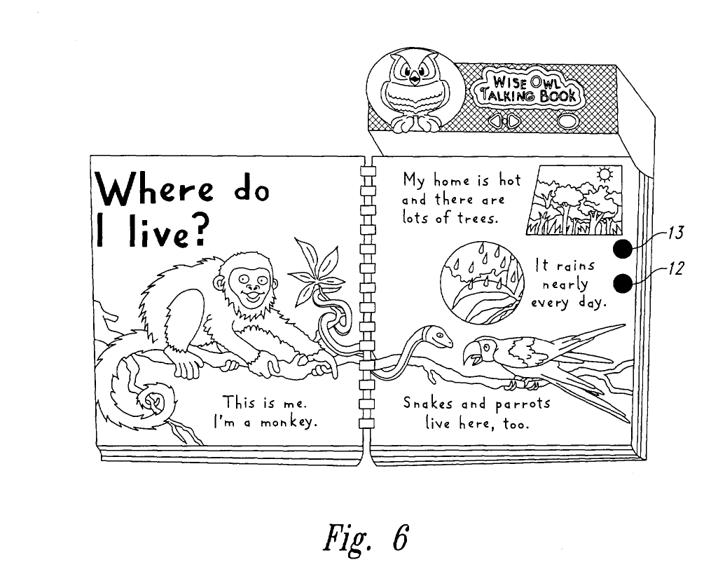

FIG. 6 illustrates another page of the book according to the present utility model. On the top right hand corner of the figure, there is a box-like container (26) with a pencil case shape, which is linked with the book. On the left page of the book, there are some English words and a monkey. On the right page, there are some English words and a parrot. Between the right and left pages, there is a snake. On the right margin of the right page, there is a page selection contact (12) and a stop contact (13).

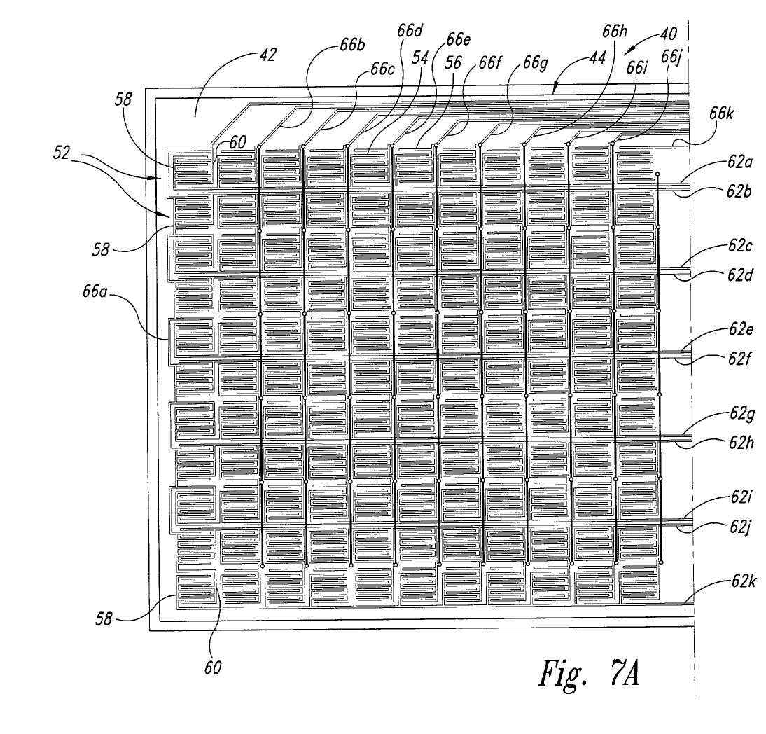

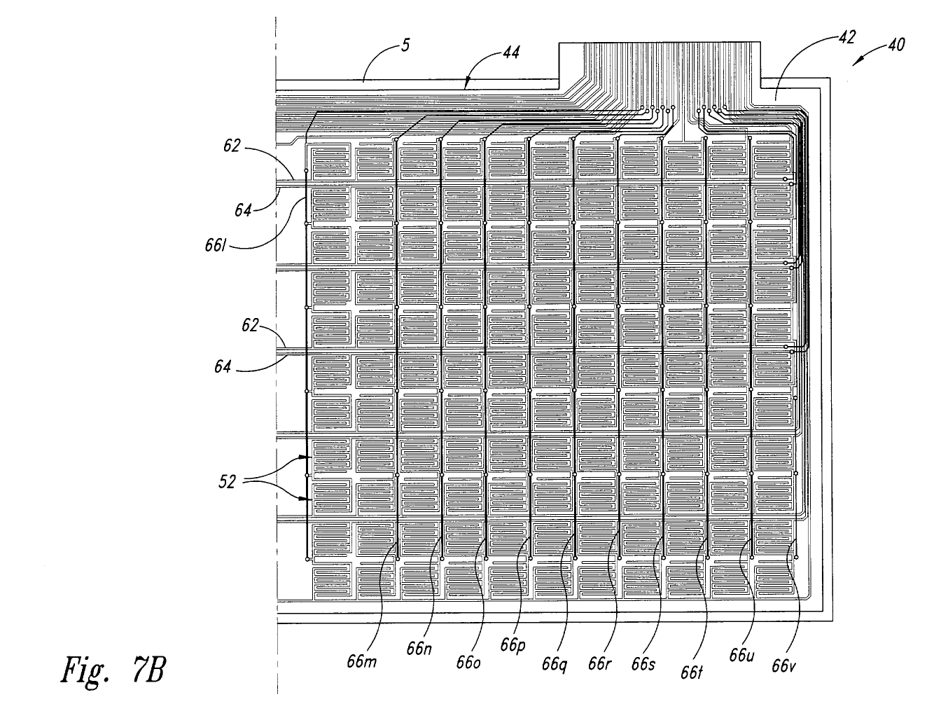

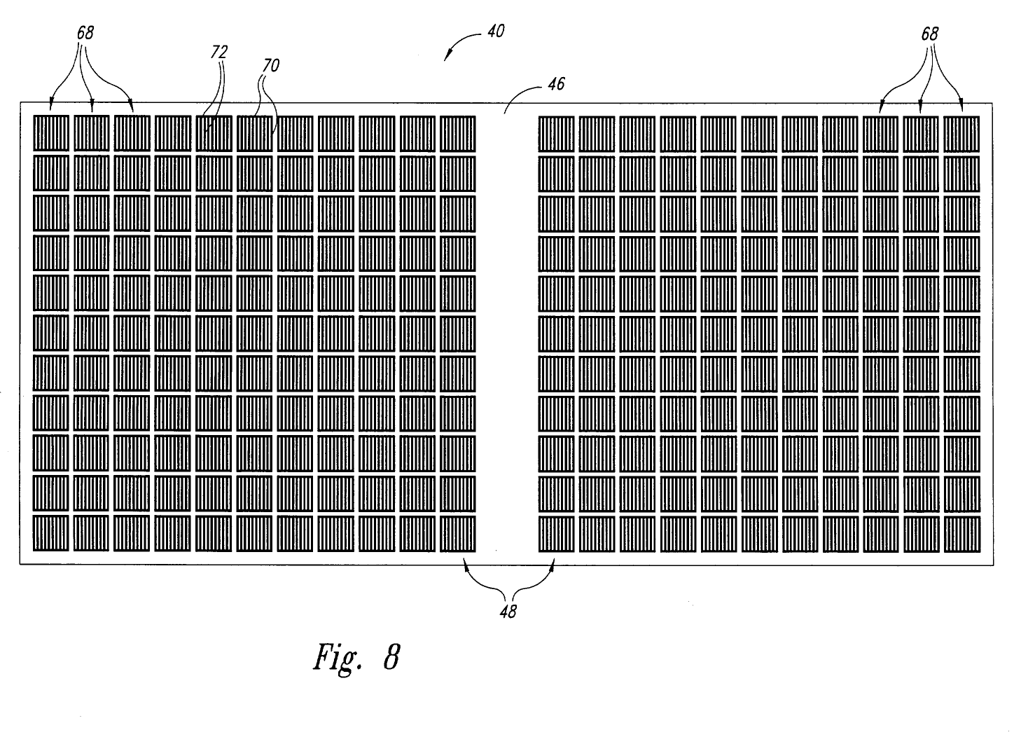

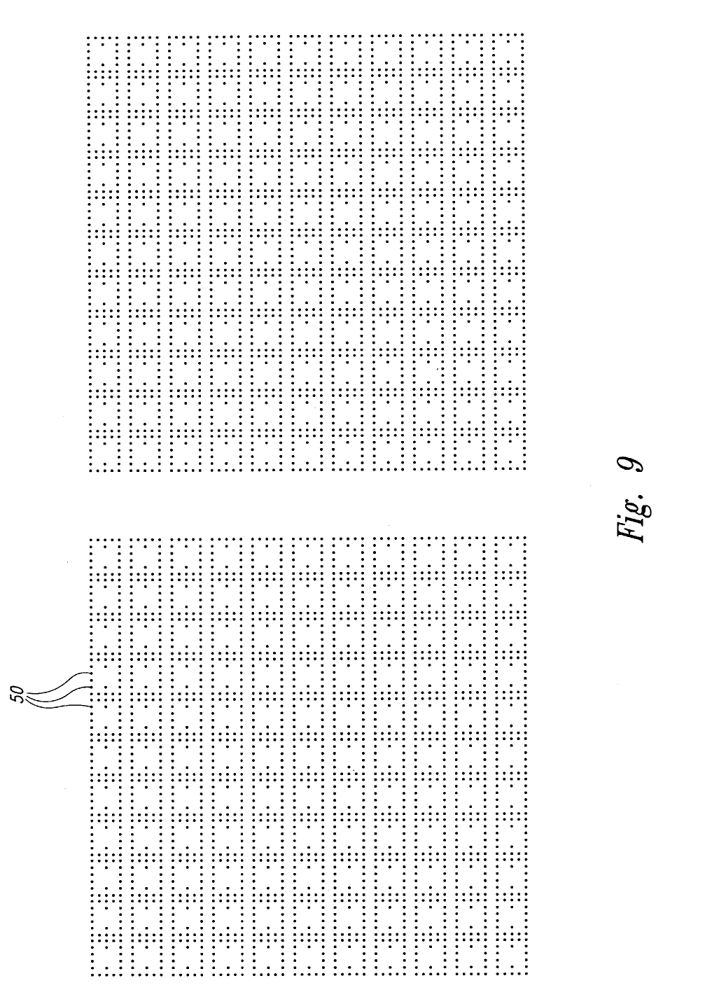

FIGS. 7-9 are schematic diagrams of an embodiment of the invention in which the press trigger printed circuit board 21 is implemented in a composite membrane 40 affixed to the cover 5 of the book 1. The membrane 40 includes a flexible, first thin film 42 carrying a first circuit portion 44 (FIGS. 7A-7B) and a flexible, second thin film 46, carrying a second circuit portion 48 (FIG. 8), that are bonded together and to the book cover 5. The first thin film 42 also includes a pattern of non-conductive protuberances 50 (FIG. 9) that cause the first circuit portion 44 to be spaced apart and insulated from the second circuit portion 48. The portion of the membrane 40 in FIG. 7A and at the left side of each of FIGS. 8-9 is affixed to the front cover of the book 1, the portion in FIG. 7B and at the right side of each of FIGS. 8-9 is affixed to the back cover of the book, and the central portion is positioned along the spine of the book. The thin films 42, 46 are composed of polyester in one example, but could be composed of any of numerous dielectric film materials.

The first circuit portion 44 includes numerous circuit modules 52: 121 modules in FIGS. 7A and 121 in FIG. 7B. Each module 52 is composed of a conductive E-shaped circuit 54 of conductive lines or teeth interleaved with respective conductive teeth of an inverse E-shaped circuit 56. The teeth of the E circuit 54 extend left to right from a vertical, first connector line 58 and the teeth of the inverse E circuit 56 extend right to left from a vertical, second connector line 60.

The first circuit portion 44 also includes eleven independent, horizontal row connector lines 62a-62k that respectively connect all of the modules 52 within a respective row with each other. In particular, the E circuits 54 of the first row are connected to the first row connector line 62a, the inverse E circuits 56 of the second row are connected to the second row connector line 62b, the E circuits of the third row are connected to the third row connector line 62c, and so forth. A set of independent, column connector lines 66a-66v respectively connect the all of the modules 52 within a respective column with each other. In particular, the odd-numbered inverse E circuits 56 (i.e., those in the first, third, fifth, seventh, ninth, and eleventh rows) and even-numbered E circuits 54 (i.e., those in the second, fourth, sixth, eighth, and 10 rows) of the first column are connected to the first column connector line 62a, the odd-numbered inverse E circuits 56 and even-numbered E circuits 54 of the second column are connected to the second column connector line 62b, and so forth. The connector lines 62a-k and 66a-v connect the first circuit portion 44 to the circuit for storage and sound transmission 23 within the box-like container 26.

As shown in FIG. 8, the second circuit portion 48 includes a set of conductive, square modules 68 arranged to correspond in number and positioning to the circuit modules 52 of the first circuit portion 44. That is, each square module 68 is positioned over a corresponding circuit module 52 of the first circuit portion 44. In effect, each circuit module 52 and the corresponding square module 68 are respective halves of one of the speech switches 30. Each of the square modules 68 includes a conductive perimeter 70 and a set of conductive vertical lines 72 connected to the perimeter 70. The entire square module typically is composed of metal printed on the second plastic film 46, which typically is a polyester film. Of course, other conductive materials and shapes could be employed for the modules 68 without departing from the invention.

As shown in FIG. 9, the protuberances 50 are arranged in a pattern such that each module 68 of the second circuit portion 48 is spaced and insulated from the corresponding circuit module 52 of the first circuit portion 44. In particular, the protuberances 50 are arranged around the perimeter of each circuit module 52 and two protuberances are arranged within each circuit module 52. In a preferred embodiment, the thickness of the protuberances 50 is within a range of 0.2-0.3 mm with 0.25 mm being the most preferred. The protuberances 50 are printed on the first thin film 42 using a dielectric ink that is cured by ultraviolet (UV) light to initiate cross-linking with the polyester that comprises the first thin film. One example of such a dielectric ink is the ML 25198 ink distributed by Raymond & Co. Of course, other materials could be employed for the protuberances and thin films 42, 46 without departing from the invention.

The book 1 and composite membrane 40 operate as follows. When the book 1 is not touched, the protuberances 50 insulate the modules 68 of the second circuit portion 48 from the corresponding modules 52 of the first circuit portion 44. When a user presses one of the objects (such as a picture or word) on one of the pages, a selected one of the modules 68 underlying the pressed picture is forced onto the corresponding module 52 by compressing the protuberances 50 between the two modules 52, 68 and/or bending one or both of the thin films 42, 46. The vertical lines 72 of the selected module 68 thereby contact and interconnect the lines 54, 56 of the corresponding module 52. The interconnection, in effect, closes one of the speech switches 30 and completes a circuit that includes the selected and corresponding modules 68, 52 and the circuit for storage and sound transmission 23 within the box-like container 26. This causes the circuit 23 to perform some function, such as reading a story about or discussion of the pressed picture, playing a song, stopping a previous function, performing an internal function like changing the language used for subsequently-pressed objects. The function to be performed can depend on numerous factors, such as which module 68 is pressed, the number of modules 68 pressed, the order of the modules pressed, and the current page being read when the object is pressed.

It will be appreciated that various modifications could be made to the circuit board 21 described above without departing from the invention. For example, the modules 52, 68 could be arranged in various other patterns and the individual conductive lines 54, 56, 70, 72 of the modules could be positioned and shaped in any desired way. Moreover, the first and second circuit portions 44, 48 could be designed without the modules 52, 68 and instead could include other structures for making contacts between the circuit portions. In addition, the protuberances 50 could be replaced by other structures for insulating the first and second circuit portions 44, 48 from each other while still allowing the first and second circuit portions to contact each other in response to a user pressing an object over part of the circuit portions.

A book according to the present invention has wide application. Its content can be of great varieties. Because it is educational, it will be widely accepted.

All of the above U.S. patents, U.S. patent application publications, U.S. patent applications, foreign patents, foreign patent applications and non-patent publications referred to in this specification and/or listed in the Application Data Sheet, including but not limited to Chinese patent application no. 01278183.5 from which this application claims priority, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A book device that can read aloud sentences in one or more languages, comprising:
a book with a cover and pages that include objects; and
a speech circuit that reads aloud information about the objects in the book, the speech circuit including:
a printed circuit containing speech switches, the printed circuit being inside the cover of the book;
a speaker;
a battery connected to power the printed circuit and speaker; and
a circuit for storage and sound emission connected to the printed circuit, speaker and battery, wherein the circuit for storage and sound emission, speaker and battery are in a box-like container outside the book, and the circuit for storage and sound emission stores recorded sounds of the book, such that in response to a user pressing an object on a selected page, a corresponding one of the speech switches will be switched on, which causes the circuit for storage and sound emission to cause the speaker to read aloud specified contents about the pressed object, wherein the printed circuit includes first and second circuit portions positioned on first and second films, respectively, and an insulator that insulates the first and second circuit portions from each other, the first and second circuit portions together forming the speech switch that is switched on when the first and second circuit portions are pressed together by the user pressing the object.

2. A book device according to claim 1, wherein the printed circuit includes a plurality of press trigger switches and each page of the book includes a respective page selection contact corresponding in position to a respective one of the press trigger switches for page selection, wherein in response to a user turning to a certain page, pressing its page selection contact to turn on the corresponding press trigger switch, and then pressing an object on the certain page to turn on the corresponding speech switch, the speech circuit causes the speaker to read aloud words corresponding to the pressed object on the certain page.

3. A book device according to claim 2 wherein the page selection contacts are placed on a margin of every page and the location of each page selection contact on each page is different from the locations of other page selection contacts for other pages.

4. A book device according to claim 1, wherein the insulator includes a plurality of dielectric protuberances printed on one of the films, the protuberances spacing the first and second circuit portions from each other and being spaced from each other to allow the first and second circuit portions to contact in areas between at least some of the protuberances.

5. A book device according to claim 1 wherein the first circuit portion includes a plurality of first circuit modules that are spaced apart from each other and the second circuit portion includes a plurality of second circuit modules that are spaced apart from each other, each of the first circuit modules forming, together with a corresponding one of the second circuit modules, a respective one of the speech switches.

6. A book device according to claim 5 wherein each of the first circuit modules includes first and second conductive combs having respective teeth that are interspersed with one another and each of the second circuit modules includes a conductive line that is positioned to electrically connect the teeth of the first conductive comb of the corresponding first circuit module with the teeth of the second conductive comb of the corresponding first circuit module, in response to the user pressing an object positioned above the second circuit module and the corresponding first circuit module.

7. A book device according to claim 6, wherein each of the second circuit modules includes a conductive perimeter and a plurality of conductive lines extending between opposite sides of the conductive perimeter.

8. A book device according to claim 5, wherein the insulator includes a plurality of dielectric protuberances printed on one of the films, the protuberances spacing the first and second circuit portions from each other and being spaced from each other to allow the first and second circuit portions to contact in areas between at least some of the protuberances.

9. A book device according to claim 8 wherein the protuberances are arranged in protuberance modules spaced apart from each other, each protuberance module including a set of protuberances arranged along a perimeter of a corresponding one of the first circuit modules.

10. A book device according to claim 1 wherein the speech circuit includes a stop contact on every page to avoid emitting sound that does not correspond with the pictures on the page.

11. A book device according to claim 1, wherein the circuit for storage and sound emission stores sounds for each page in a plurality of languages that can be selected by a user.

12. A book device that can read aloud sentences in one or more languages, comprising:
a book with a cover and pages that include objects; and
a speech circuit that reads aloud information about the objects in the book, the speech circuit including:
a speaker;
a storage and sound emission circuit connected to the speaker, wherein the storage and sound emission circuit stores recorded sounds of the book, such that in response to a user pressing an object on a selected page, causes the speaker to read aloud specified contents about the pressed picture; and
a switch circuit positioned within the book and connected to the storage and sound emission circuit, the switch circuit including first and second circuit portions positioned on first and second films, respectively, and an insulator that insulates the first and second circuit portions from each other, the first and second circuit portions together forming a speech switch that is switched on when the first and second circuit portions are pressed together by the user pressing the object.

13. The book device of claim 12, wherein the switch circuit includes a plurality of press trigger switches and each page of the book includes a respective page selection contact corresponding in position to a respective one of the press trigger switches for page selection, wherein in response to a user turning to a certain page, pressing its page selection contact to turn on the corresponding press trigger switch, and then pressing an object on the certain page to turn on the corresponding speech switch, the speech circuit causes the speaker to read aloud words corresponding to the pressed object on the certain page.

14. The book device of claim 12, wherein the insulator includes a plurality of dielectric protuberances printed on one of the films, the protuberances spacing the first and second circuit portions from each other and being spaced from each other to allow the first and second circuit portions to contact in areas between at least some of the protuberances.

15. The book device of claim 12 wherein the first circuit portion includes a plurality of first circuit modules that are spaced apart from each other and the second circuit portion includes a plurality of second circuit modules that are spaced apart from each other, each of the first circuit modules forming, together with a corresponding one of the second circuit modules, a respective one of a plurality of speech switches.

16. The book device of claim 15 wherein each of the first circuit modules includes first and second conductive combs having respective teeth that are interspersed with one another and each of the second circuit modules includes a conductive line that is positioned to electrically connect the teeth of the first conductive comb of the corresponding first circuit module with the teeth of the second conductive comb of the corresponding first circuit module, in response to the user pressing an object positioned above the second circuit module and the corresponding first circuit module.

17. A book device according to claim 16, wherein each of the second circuit modules includes a conductive perimeter and a plurality of conductive lines extending between opposite sides of the conductive perimeter.

18. A book device according to claim 15, wherein the insulator includes a plurality of dielectric protuberances printed on one of the films, the protuberances spacing the first and second circuit portions from each other and being spaced from each other to allow the first and second circuit portions to contact in areas between at least some of the protuberances.

19. A book device according to claim 18 wherein the protuberances are arranged in protuberance modules spaced apart from each other, each protuberance module including a set of protuberances arranged along a perimeter of a corresponding one of the first circuit modules.

20. A switch circuit for a book that emits speech according to objects appearing on pages of the book, the switch circuit comprising:
a first circuit portion formed on a first dielectric film and including a plurality of first circuit modules spaced apart from one another, each of the first circuit modules including a conductive line pattern;
a second circuit portion formed on a second dielectric film and including a plurality of second circuit modules spaced apart from one another, each of the second circuit modules including a conductive line pattern and corresponding to a respective one of the first circuit modules; and
an insulator pattern formed on one of the dielectric films and positioned between the first and second circuit portions, the insulator pattern defining a gap between each of the first circuit modules and the corresponding second circuit module such that the first circuit module is spaced apart from the corresponding second circuit module while in a rest state and the first circuit module contacts the corresponding second circuit module while in a pressed state in which a user forces the contact.
